(19) United States
(12) Patent Application Publication
(10) Pub. No.: US 2007/0030899 A1
(43) Pub. Date: Feb. 8, 2007

(54) MOTION ESTIMATION APPARATUS

(75) Inventors: Masayasu IGUCHI, Osaka (JP); Takeshi TANAKA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/461,493

(22) Filed: Aug. 1, 2006

(30) Foreign Application Priority Data
Aug. 2, 2005 (JP) 2005/224525

(51) Int. Cl. H04N 7/12

(52) U.S. Cl. 375/240.12; 375/240.26

(57) ABSTRACT

A motion estimation apparatus, which can prevent a system breakdown without evenly lowering the quality of a picture to be decoded, includes: a reference picture setting unit which restricts a data transfer amount of image data to be transferred from an external multi-frame memory, in accordance with a data transfer capability of the external multi-frame memory for storing the image data; a reference local memory; a reference memory control unit which transfers, to the reference local memory, at least a portion of the image data stored in the external multi-frame memory, which is the data transfer amount restricted by the reference picture setting unit; and a motion estimation unit which performs motion estimation of the picture to be coded with reference to the at least the portion of the image data transferred to the reference local memory.

### BACKGROUND OF THE INVENTION

(1) Field of the Invention

The present invention relates to a motion estimation apparatus which performs motion estimation using reference pictures.

(2) Description of the Related Art

Recently, with the arrival of the age of multimedia in which audio, video and other pixel values are integrally handled, existing information media, i.e., newspapers, journals, TVs, radios and telephones and other means through which information is conveyed to people has come under the scope of multimedia. Generally speaking, multimedia refers to something that is represented by associating not only characters but also graphics, audio and especially images and the like together. However, in order to include the aforementioned existing information media in the scope of multimedia, it appears as a prerequisite to represent such information in digital form.

However, when estimating the amount of information contained in each of the aforementioned information media as the amount of digital information, the information amount per character requires 1 to 2 bytes whereas the audio requires more than 64 Kbits (telephone quality) per second, and when it comes to the moving picture, it requires more than 100 Mbits (present television reception quality) per second. Therefore, it is not realistic for the information media to handle such an enormous amount of information as it is in digital form. For example, although video phones are already in the actual use via Integrated Services Digital Network (ISDN) which offers a transmission speed of 64 Kbit/s to 1.5 Mbit/s, it is impossible to transmit images on televisions and images taken by cameras directly through ISDN.

This therefore requires information compression techniques, and for instance, in the case of the videophone, video compression techniques compliant with H.261 and H.263 standards recommended by International Telecommunication Union-Telecommunication Standardization Sector (ITU-T) are employed. According to the information compression techniques compliant with the MPEG-1 standard, image information as well as audio information can be stored in an ordinary music Compact Disc (CD).

Here, Moving Picture Experts Group (MPEG) is an international standard for compression of moving picture signals standardized by International Standards Organization/International Electrotechnical Commission (ISO/IEC), and MPEG-1 is a standard to compress moving picture signals down to 1.5 Mbps, that is, to compress information of TV signals approximately down to a hundredth. The transmission rate within the scope of the MPEG-1 standard is set to about 1.5 Mbps to achieve the middle-quality picture, therefore, MPEG-2 which was standardized with the view to meet the requirements of high-quality picture allows data transmission of moving picture signals at a rate of 2˜15 Mbps to achieve the quality of TV broadcasting. In the present circumstances, a working group (ISO/IEC JTC1/SC29/WG11) in the charge of the standardization of the MPEG-1 and the MPEG-2 has achieved a compression rate which goes beyond what the MPEG-1 and the MPEG-2 have achieved, further enabled coding/decoding operations on a per-object basis and standardized MPEG-4 in order to realize a new function required by the era of multimedia. In the process of the standardization of the MPEG-4, the standardization of coding method for a low bit rate was aimed. However, the aim is presently extended to a more versatile coding of moving pictures at a high bit rate including interlaced pictures.

Furthermore, MPEG-4 AVC and H.264 have been standardized since 2003 as a picture coding method with higher compression rate, which are jointly worked by the ISO/IEC and the ITU-T (for example, refer to Non-Patent Reference 1: ISO/IEC 14496-10, International Standard: “Information Technology—Coding of Audio-Visual Objects Part 10: Advanced Video Coding”, Oct. 1, 2004). Currently, regarding H.264, a draft of its revised standard in compliance with a High Profile which is suited for High Definition (HD) pictures have been developed. As an application in compliance with H.264 standard, it is expected, as in the cases of the MPEG-2 and MPEG-4, that the application extends to digital broadcast, a Digital Versatile Disk (DVD) player/recorder, a hard disc player/recorder, a camcorder, a video phone and the like.

In general, in coding of a moving picture, the amount of information is compressed by reducing redundancy in temporal and spatial directions. Therefore, an inter-picture prediction coding, which aims at reducing the temporal redundancy, estimates a motion and generates a predictive picture on a block-by-block basis with reference to prior and subsequent pictures, and then codes a differential value between the obtained predictive picture and a current picture to be coded. Here, “picture” is a term to represent a single screen and it represents a frame when used for a progressive picture whereas it represents a frame or fields when used for an interlaced picture. The interlaced picture here is a picture in which a single frame consists of two fields respectively having different time. For encoding and decoding an interlaced picture, a single frame can be processed either as a frame, as two fields or as a frame/field structure depending on a block in the frame.

A picture to which an intra-picture prediction coding is performed without reference pictures is referred to as an “I-picture”. A picture to which the inter-picture prediction coding is performed with reference to a single picture is referred to as a “P-picture”. A picture to which the inter-picture prediction coding is performed by referring simultaneously to two pictures is referred to as a “B-picture”. The B-picture can refer to two pictures, selected from the pictures whose display time is either forward or backward to that of a current picture to be coded, as an arbitrary combination. Whereas the reference pictures can be specified for each macroblock that is a fundamental unit of coding, they are distinguished as a first reference picture and a second reference picture. Here, the first reference picture is a first reference picture to be described firstly in a coded bit stream and the second reference picture is a reference picture to be described after the first reference picture in the coded bit stream. However, the reference pictures need to be already coded as a condition to code these I-picture, P-picture, and B-picture.

A motion compensation inter-picture prediction coding is used for coding the P-picture or the B-picture. The motion compensation inter-picture prediction coding is a coding method which adopts motion compensation to an inter-picture prediction coding. The motion compensation is a method of reducing the amount of data while increasing prediction precision by estimating an amount of motion (this is referred to as a motion vector, hereinafter) of each part in a picture and performing prediction in consideration of the estimated amount of data, instead of simply predicting a picture from a pixel value of a reference frame. For example, the amount data is reduced by estimating a motion vector of a current picture to be coded and coding a predictive difference between a predicted value which is shifted as much as the estimated motion vector and the current picture. Since this method requires information about the motion vector at the time of decoding, the motion vector is also coded, and recorded or transmitted.

The motion vector is estimated on a macroblock basis.

Specifically, a motion vector is estimated by fixing a macroblock (standard block) of the current picture, moving a macroblock (reference block) of the reference picture within a searching range, and finding a position of the reference block which is approximate to the standard block.

FIG. 1 is a block diagram which shows a structure of a conventional picture coding apparatus.

This picture coding apparatus 800 includes a motion estimation unit 801, a multi-frame memory 802, a subtractor 803, a subtractor 804, a motion compensation unit 805, a coding unit 806, an adder 807, a motion vector memory 808, and a motion vector prediction unit 809.

The motion estimation unit 801 compares a motion estimation reference pixel MEp outputted from the multi-frame memory 802 with an image signal Vin, and outputs a motion vector MV and a reference frame number RN.

The reference frame number RN is an identification signal for identifying a reference picture to be selected from among plural reference pictures as a reference picture for a current picture to be coded.

The motion vector MV is temporally stored in the motion vector memory 808, and then outputted as a neighboring motion vector PvMV. This neighboring motion vector PvMV is referred to for predicting a predictive motion vector PdMV by the motion vector prediction unit 809.

The subtractor 804 subtracts the predictive motion vector PdMV from the motion vector MV, and outputs the difference as the motion vector predictive difference DMV.

On the other hand, the multi-frame memory 802 outputs a pixel indicated by the reference frame number RN and the motion vector MV as a motion compensation reference pixel MCp1 and the motion compensation unit 805 generates a reference pixel in sub-pixel precision and outputs a reference picture pixel MCp2. The subtractor 803 subtracts the reference picture pixel MCp2 from the image signal Vin, and outputs a picture predictive difference DP.

The coding unit 806 performs variable-length coding on the picture predictive difference DP, the motion vector predictive difference DMV, and the reference frame number RN, and outputs the coded stream Str. It should be noted that, upon coding, a decoded picture predictive difference RDP, which is a result of decoding the picture predictive difference DP, is simultaneously outputted. The decoded picture predictive difference RDP is obtained by superimposing the coded difference on the picture predictive difference DP, and is same as the inter-picture predictive difference which is obtained by which the picture decoding apparatus decodes the coded stream Str.

The adder 807 adds the decoded picture predictive difference RDP to the reference picture pixel MCp2, and stores the resultant into the multi-frame memory 802 as a decoded picture RP. However, for an effective use of the capacity of the multi-frame memory 802, a region of the picture stored in the multi-frame memory 802 is released when it is not necessary, and the decoded picture RP of the picture which is not necessary to be stored in the multi-frame memory 802 is not stored into the multi-frame memory 802.

FIG. 2 is a block diagram for explaining a conventional picture decoding apparatus. Note that, in FIG. 2, same reference numbers are attached to the constituent elements that are same in FIG. 1, and the overlapping explanations are therefore omitted in here.

The conventional picture decoding apparatus 900 shown in FIG. 2 outputs a decoded image signal Vout by decoding the coded stream Str coded by the conventional picture coding apparatus 800 shown in FIG. 1. The picture decoding apparatus 900 includes a multi-frame memory 901, a motion compensation unit 902, an adder 903, an adder 904, a motion vector memory 905, a motion vector prediction unit 906, and a decoding unit 907.

The decoding unit 907 decodes the coded stream Str, and outputs a decoded picture predictive difference RDP, a motion vector predictive difference DMV, and a reference frame number RN.

The adder 904 adds a predictive motion vector PdMV outputted from the motion vector prediction unit 906 and the motion vector predictive difference DMV, and decodes a motion vector MV.

The multi-frame memory 901 outputs a pixel indicated by the reference frame number RN and the motion vector MV as a motion compensation reference pixel MCp1. The motion compensation unit 902 generates a reference pixel with a sub-pixel precision and outputs a reference picture pixel MCp2. The adder 903 adds the decoded picture predictive difference RDP to the reference picture pixel MCp2, and stores the sum into the multi-frame memory 901 as a decoded picture RP (a decoded image signal Vout). However, for an effective use of the capacity of the multi-frame memory 901, a region of the picture stored in the multi-frame memory 901 is released when it is not necessary, and the decoded picture RP of a picture which is not necessary to be stored in the multi-frame memory 901 is not stored into the multi-frame memory 901. Accordingly, the decoded image signal Vout, that is the decoded picture RP, can be correctly decoded from the coded stream Str.

By the way, there is a suggested structure (for example, refer to Patent Reference 1: Japanese Patent No. 2963269) for mounting the conventional picture coding apparatus 800 shown in FIG. 1 onto a Large Scale Integration (LSI). As shown in the Patent Reference 1, in the case where the picture coding apparatus is mounted on an LSI and the like, the multi-frame memory 802 of the conventional picture coding apparatus 800 shown in FIG. 1 is divided into and mounted as an external frame memory placed outside the LSI and a local memory in the LSI which is directly accessed to when the motion estimation unit 801 searches for a block matching.

FIG. 3 is an explanation diagram for explaining a picture coding apparatus which is configured using the LSI. Note that, in FIG. 3, same reference numbers are attached to the constituent elements that are same in FIG. 1, and the overlapping explanations are therefore omitted in here.

The picture coding apparatus 800a is made up of an LSI 810 and an external multi-frame memory 820. The external multi-frame memory 820 is a memory which is connected to the LSI 810.

The LSI 810 includes all constituent elements other than the multi-frame memory 802 of the picture coding apparatus 800, and includes a reference local memory 811, which is used for reference, in place of the multi-frame memory 802. The reference local memory 811 is a local memory in the LSI 810 which is directly accessed to when the motion estimation unit 801 searches for a block matching. Note that, in FIG. 3, all constituent elements included in the LSI 810, other than the reference local memory 811 and the motion estimation unit 801, are omitted.

In FIG. 3, when the motion estimation unit 801 performs motion estimation, a picture region to be searched is firstly transferred from the external multi-frame memory 820 to the reference local memory 811 via an external connection bus Bus1. Next, data is read out from the reference local memory 811 via an internal bus Bus2, and motion estimation is performed by the motion estimation unit 801. With such structure, the pixel transfer amount (the number of pixels to be transferred) of the external connection bus Bus1 and the internal memory capacity of the LSI 810 are reduced.

FIG. 4 is a diagram showing a detailed structure of a picture coding apparatus having the aforementioned external multi-frame memory 820 and the reference local memory 811.

The picture coding apparatus 800a includes the external multi-frame memory 820 and the reference local memory 811 in place of the multi-frame memory 802 of the picture coding apparatus 800, and includes a reference memory control unit 812 which controls the external multi-frame memory 820 and the reference local memory 812.

As similar to the operations of the picture coding apparatus 800 shown in FIG. 1, a decoded picture RP that is a sum obtained by the adder 807 is stored into the external multi-frame memory 820. Next, the external multi-frame memory 820 outputs a region to be used for motion compensation prediction and the like, to the reference local memory 811. Furthermore, the reference memory control unit 812 controls data transfer between the external multi-frame memory 820 and the reference local memory 811.

In such picture coding apparatus 800a, a conventional motion estimation apparatus 850 includes the motion estimation unit 801, the reference local memory 811, and the reference memory control unit 812.

Here, it shall be explained an application example of the picture coding apparatus 800a.

FIG. 5 is a block diagram showing an AV processing apparatus which realizes an H.264 recorder.

An AV processing apparatus 700 includes a memory 710, and an LSI 720 which is configured as a DVD recorder, a hard disk recorder and the like which reproduce digital-compressed audio and video.

The memory 710 is a memory into which stream data St indicating audio and video (here, video indicates a picture or an image) and data such as encoded data and decoded data are stored. It includes a region of the external multi-frame memory 820 shown in FIG. 4.

The LSI 720 includes a bas B, a video coding/decoding unit 721, an audio coding/decoding unit 722, a video processing unit 723, a picture input/output unit 724, an audio processing unit 725, an audio input/output unit 726, a stream input/output unit 727, a memory input/output unit 728, and an AV control unit 729.

The bus B is used for transferring stream data St and data such as decoded data of audio/video. The stream input/output unit 727 inputs the stream data St, and outputs the input stream data St via the bus B. The video coding/decoding unit 721 is connected to the bus B and performs coding and decoding of video. The audio coding/decoding unit 722 is connected to the bus B and performs coding and decoding of audio. The memory input/output unit 728 is connected to the bus B and serves as an input/output interface of a data signal to the memory 710.

The video processing unit 723 is connected to the bus B and performs pre-processing and post-processing on a video signal. The video input/output unit 724 outputs, to the outside, as a video input/output signal VS, the video signal which has processed by the video processing unit 723 or which has passed through the video processing unit 723 without being processed by the video processing unit 723, or captures a video input/output signal VS from the outside.

The audio processing unit 725 is connected to the bus B, and performs pre-processing and post-processing on an audio signal. The audio input/output unit 726 outputs, to the outside, as an audio input/output signal AS, the audio signal which has processed by the audio processing unit 725 or which has passed through the audio processing unit 725 without being processed by the audio processing unit 725, or captures an audio input/output signal AS from the outside. The AV control unit 729 controls an entire LSI 720.

Here, it shall be explained a coding operation performed by the AV processing apparatus 700. First, a video input/output signal VS is inputted to the video input/output unit 724, and an audio input/output signal AS is inputted to the audio input/output unit 726.

The video processing unit 723 performs filtering, characteristic amount extraction for coding and the like on the video input/output signal VS inputted to the video input/output unit 724, and stores the processed video input/output signal VS into the memory 710 via the memory input/output unit 728 as an original picture. Next, the video coding/decoding unit 721 obtains the original picture and a reference picture from the memory 710 via the memory input/output unit 728, and transmits, to the memory 710, the video stream data (coded stream Str) coded by the video coding/decoding unit 721 and local decoded data.

Here, the picture coding/decoding unit 721 includes all constituent elements except the external multi-frame memory 820 of the picture coding apparatus 800a shown in FIG. 4 and a picture decoding apparatus 900 (the multi-frame memory 901 is replaced by the local memory) shown in FIG. 2.

On the other hand, the audio processing unit 725 performs filtering, characteristic amount extraction for coding and the like on the audio input/output signal AS inputted to the audio input/output unit 726, and stores the processed audio input/output signal AS into the memory 710 as original audio data, through the memory input/output unit 728. Next, the audio coding/decoding unit 722 captures and codes the original audio data from the memory 710 via the memory input/output unit 728, and stores the resultant into the memory 710 as audio stream data.

Lastly, the video stream data, the audio stream data and other stream information are processed as one stream data St, and the stream data St is outputted through the stream input/output unit 727. Such stream data St is then written onto a recording medium such as an optical disk and a hard disk.

However, in the motion estimation apparatus included in the picture coding apparatus of the Patent Reference 1, the data transfer rate used for motion estimation occupies significant percentage of the total data transfer rate of the external multi-frame memory 820. As a result, there is a possibility that an entire system of the AV processing apparatus is to be broken down.

Under H.264 specification, a large number of pictures may be referred to when inter-picture prediction coding is performed. Therefore, when high quality is sought, it is estimated that up-to 16 pictures under the specification having frame structures and up-to 32 pictures having field structures are to be referred. Accordingly, in the case where the number of reference pictures (reference numbers) is many, it is natural to think that the data transfer capability of the externally connected bus Bus 1 shown in FIG. 3 is a bottleneck.

FIG. 6 is a diagram for explaining the number of pictures used as reference pictures for motion estimation.

As shown in FIG. 6A, in MEPG-2 and MPEG-4, for example, a B picture B5 only refers two pictures of a P picture P3 and a P picture P6. However, as shown in FIG. 6B, in H.264, for example, the B picture B5 refers six pictures of an I picture I0, a B picture B1, a B picture B2, a P picture P3, a B picture B4 and a P picture P6. Here, it is possible to perform coding of a current picture while restricting the number of reference pictures for the current picture to the number of reference pictures as in the case of MPEG-2. However, in such case, picture quality is evenly degraded regardless of the data transfer capability of the external multi-frame memory 820 (memory 710). Accordingly, it is necessary to increase the number of reference pictures in order to obtain high quality.

Furthermore, in the case of the medium processing, the external multi-frame memory 820 holds many access requests such as picture processing other than transferring of reference pictures used for inter-picture prediction coding processing, stream data processing, audio processing, and entire control processing. Therefore, there is a lack of data transfer capability, which may cause a system breakdown.

### SUMMARY OF THE INVENTION

In view of the aforementioned problem, the object of the present invention is to provide a motion estimation apparatus which can prevent system breakdown without evenly decreasing the quality of a picture to be decoded.

In order to achieve the aforementioned object, a motion estimation apparatus according to the present invention is a motion estimation apparatus which estimates a motion of an image of a current picture to be coded, for the coding of the current picture. The motion estimation apparatus includes: a restriction unit which restricts a data transfer amount of image data to be transferred from an external memory, in accordance with a data transfer capability of the external memory in which the image data is stored; an internal memory; a transfer unit which transfers, to the internal memory, at least a portion of the image data stored in the external memory, which is the data transfer amount restricted by the restriction unit; and a motion estimation unit which performs motion estimation on the current picture, with reference to the at least the portion of the image data transferred to the internal memory. For example, the external memory holds potential reference pictures which are scheduled to be referred to for motion estimation of the current picture, and the restriction unit restricts the data transfer amount by reducing the number of the potential reference pictures.

Specifically, when the data transfer capability of the external memory is high, the data transfer amount of the image data is not restricted so that motion estimation of the current picture can be performed with reference to all of the potential reference pictures stored in the external memory as reference pictures. When the picture, which is coded by that motion estimation, is decoded, the decrease in the picture quality can be prevented. Furthermore, when the data transfer capability of the external memory is low, the data transfer amount of the image data is restricted so that, for example, only one potential reference picture is transferred to the internal memory as a reference picture from among the plural predetermined reference pictures stored in the external memory. Therefore, the breakdown of an entire system, which shares the external memory with other processes, can be prevented. Consequently, the system breakdown can be prevented without evenly decreasing the picture quality of a current picture to be decoded. Furthermore, a system designer can design a system without worrying too much about the access state of the external memory.

The restriction unit may restrict the data transfer amount by changing a reference relationship between the current picture and the image data.

For example, while the field structure requires transferring of the image data stored in the external memory with a greater data transfer amount, the frame structure only requires small data transfer amount. Accordingly, as in the present invention, even in the case where the reference relationship is changed so as to change the field structure to the frame structure, the data transfer amount of the image data to be transferred from the external memory is restricted, and, as a result, the breakdown of the system can be similarly prevented without evenly decreasing the quality of the current picture to be decoded.

Furthermore, the motion estimation apparatus includes a calculation unit which calculates a data transfer rate which can be allocated to motion estimation, out of a total data transfer rate of the external memory, and the restriction unit may restrict the data transfer amount so that a data transfer rate of the image data to be transferred from the external memory by the transfer unit is within the data transfer rate calculated by the calculation unit.

Accordingly, the data transfer rate of the image data to be transferred by the transfer unit is included in the data transfer rate that can be allocated to the motion estimation. Therefore, the breakdown of the system can be effectively prevented.

Furthermore, the calculation unit may detect a timing when there is a possibility that the data transfer rate which can be allocated to the motion estimation changes, and to calculate, at the detected timing, the data transfer rate which can be allocated to the motion estimation.

Accordingly, for example, an event occurrence time, a sequence start time and the like are detected as a timing when there is a possibility that a data transfer rate that can be allocated to motion estimation changes, and the data transfer rate is calculated at that timing. Therefore, it is always possible to calculate a proper data transfer rate and appropriately restrict the data transfer amount of the image data. In other words, an excess restriction of the data transfer amount can be prevented while effectively preventing the system breakdown.

Further, the transfer unit may transfer the image data stored in the external memory, for each region to be referred to by the motion estimation unit, and the restriction unit may restrict the data transfer amount by narrowing down the region.

Accordingly, each region is narrowed down by the restriction unit so that the data transfer amount of the image data to be transferred from the external memory is restricted. As a result, the system breakdown can be similarly prevented without evenly decreasing the quality of a current picture to be decoded.

It should be noted that the present invention can be realized not only as such motion estimation apparatus but also as a picture coding apparatus including the motion estimation apparatus, an operation method of such apparatuses, a program, a recording medium for storing the program, and an integration circuit.

As further information about technical background to this application, the disclosure of Japanese Patent Application No. 2005-224525 filed on Aug. 2, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a block diagram which shows a structure of a conventional picture coding apparatus;

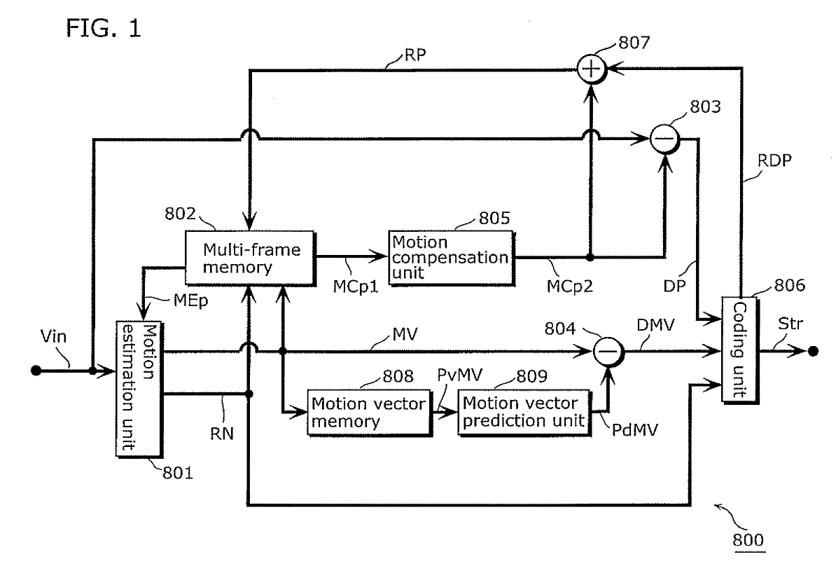

FIG. 2 is a block diagram for explaining a conventional picture decoding apparatus;

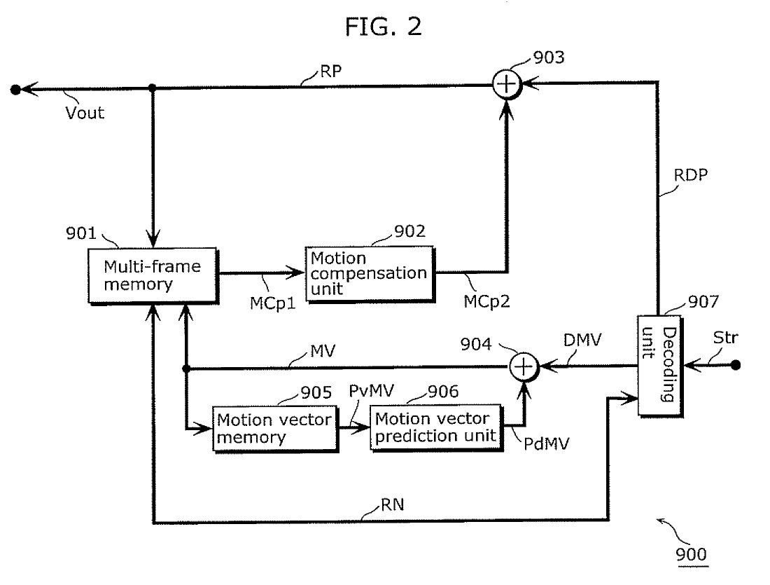

FIG. 3 is a diagram for explaining a picture coding apparatus configured of a conventional LSI;

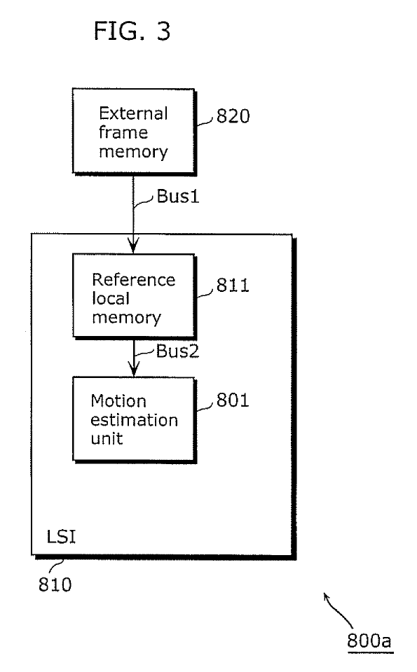

FIG. 4 is a diagram showing a detailed structure of a conventional picture coding apparatus having an external multi-frame memory and a reference local memory;

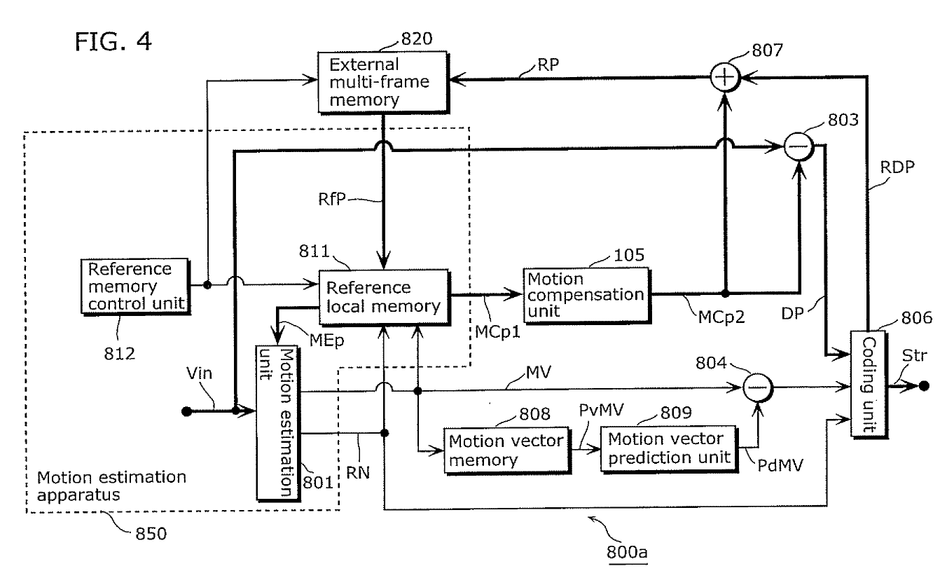

FIG. 5 is a block diagram showing an AV processing apparatus which realizes a conventional H.264 recorder;

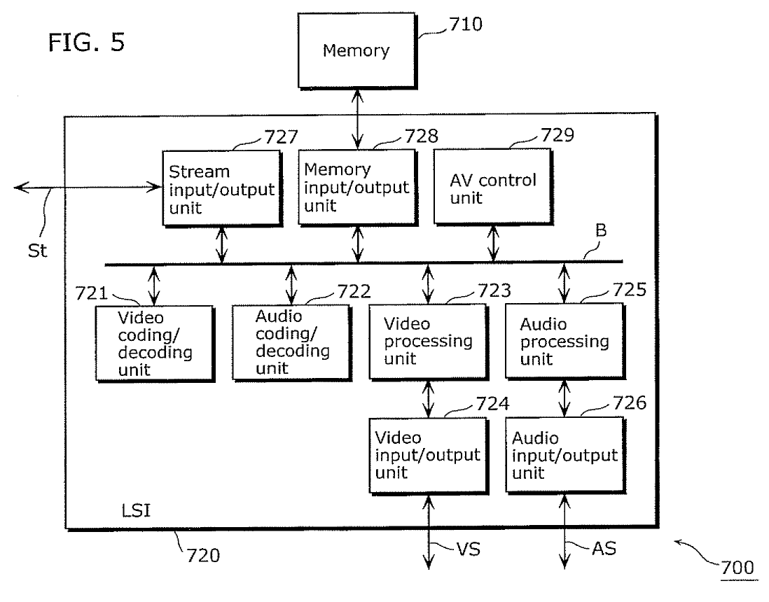

FIG. 6A and FIG. 6B are diagrams for explaining the number of pictures used as reference pictures for motion estimation;

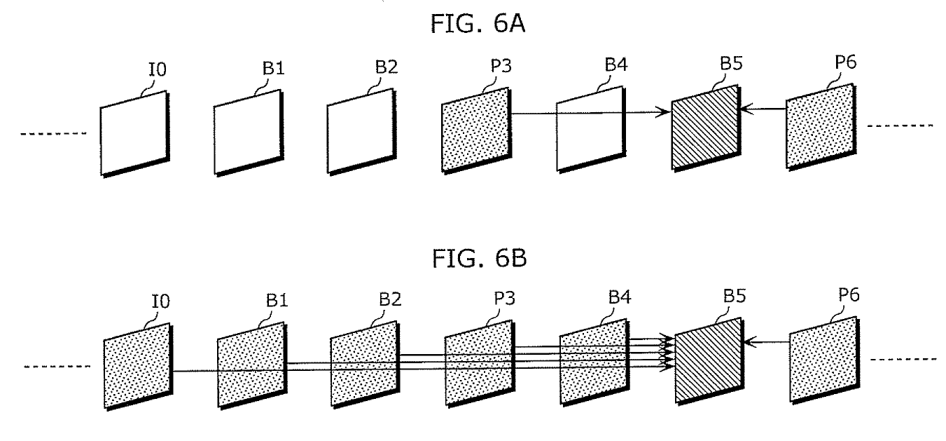

FIG. 7 is a block diagram showing a picture coding apparatus having a motion estimation apparatus according to an embodiment of the present invention;

FIG. 8 is a diagram showing a structure of an AV processing apparatus having the picture coding apparatus according to the embodiment of the present invention;

FIG. 9 is a flowchart showing an overall operation performed by the motion estimation apparatus according to the embodiment of the present invention;

FIG. 10 is a flowchart showing detailed processing of determining a memory transfer capability according to the embodiment of the present invention;

FIG. 11 is a flowchart showing detailed processing of calculating a data transfer rate according to the embodiment of the present invention;

FIG. 12 is a diagram for explaining an outline of transfer processing and motion estimation processing according to the embodiment of the present invention;

FIG. 13 is a flowchart showing transfer processing performed by a reference memory control unit according to the embodiment of the present invention;

FIG. 14 is a flowchart showing motion estimation processing performed by a motion estimation unit according to the embodiment of the present invention;

FIG. 15 is a flowchart showing conventional motion estimation processing;

FIG. 16 is a flowchart showing motion estimation processing performed by a motion estimation unit according to a first variation of the embodiment of the present invention;

FIG. 17 is a flowchart showing an overall operation of a motion estimation apparatus according to a second variation of the embodiment of the present invention;

FIG. 18A and FIG. 18B are schematic diagrams for explaining a GOP structure according to a third variation of the embodiment of the present invention; and

FIG. 19A to FIG. 19D are diagrams for explaining a process of narrowing down a search range according to a fourth variation of the embodiment of the present invention.

### DESCRIPTION OF THE PREFERRED EMBODIMENT

Hereinafter, it shall be described about a picture coding apparatus having a motion estimation apparatus according to the embodiment of the present invention.

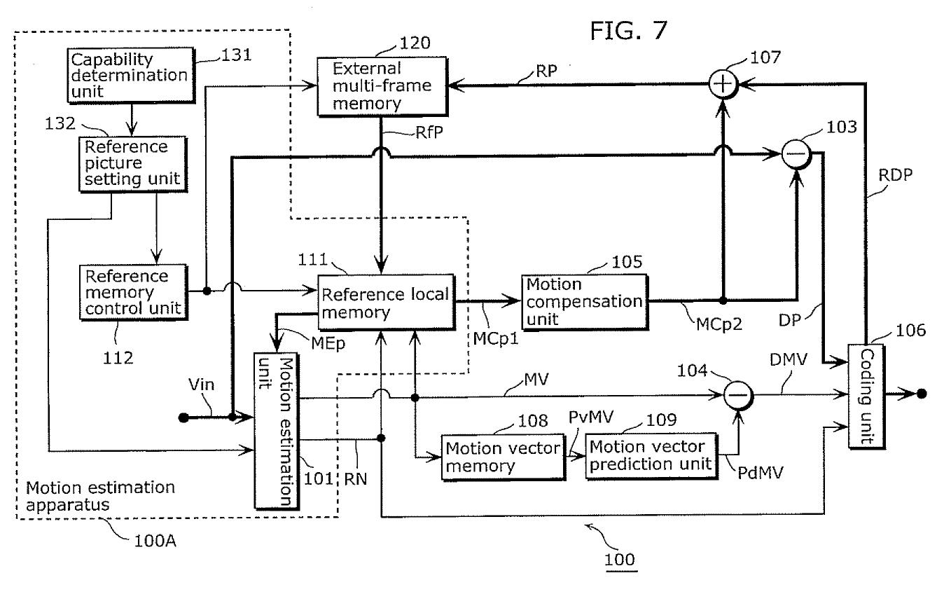

FIG. 7 is a block diagram showing the picture coding apparatus having the motion estimation apparatus according to the embodiment of the present invention.

A picture coding apparatus 100 according to the present embodiment includes a motion estimation unit 101, a subtractor 103, a subtractor 104, a motion compensation unit 105, a coding unit 106, an adder 107, a motion vector memory 108, a motion vector prediction unit 109, a reference local memory 111, a reference memory control unit 112, an external multi-frame memory 120, a capability determination unit 131 and a reference picture setting unit 132.

Furthermore, a motion estimation apparatus 100A according to the present embodiment is an apparatus for preventing a system breakdown without evenly decreasing the quality of a picture to be decoded. It includes a motion estimation unit 101, a reference local memory 111, a reference memory control unit 112, a capability determination unit 131, and a reference picture setting unit 132.

The motion estimation apparatus 100A according to the present embodiment restricts the number of reference pictures (a potential reference picture) specified in a specification and the like for a picture to be coded, and estimates a motion of a current picture to be coded using the restricted number of reference pictures.

The motion estimation unit 101 obtains a motion estimation reference pixel MEp (a reference picture or image data in a search region that is a part of the reference picture) from the reference local memory 111, and estimates a motion vector MV by comparing the motion estimation reference pixel MEp with an image signal Vin. The motion estimation unit 101 then outputs the motion vector MV and a reference frame number RN indicating a reference picture (a frame) corresponding to that motion vector MV.

Specifically, the motion estimation unit 101 searches for, per macroblock of a picture to be coded indicated by the image signal Vin, a region having an image which is approximate to the current macroblock from a reference picture (or a search region that is a part of that reference picture) stored in the reference local memory 111, and estimates a motion vector MV indicating that region with reference to that reference picture. Here, the motion estimation unit 101 estimates a motion vector MV with reference to not all of the reference pictures (potential reference pictures) specified in a specification and the like for the picture to be coded, but to only reference pictures set by the reference setting unit 132 from among the all reference pictures.

The motion vector MV estimated by the motion estimation unit 101 is temporally stored in the motion vector memory 108. The motion vector prediction unit 109 obtains a motion vector MV stored in the motion vector memory 108 as a neighboring motion vector PvMV, and predicts and outputs a predictive motion vector PdMV using the neighboring motion vector PvMV.

The subtractor 104 subtracts the predictive motion vector PdMV from the motion vector MV, and outputs the difference as a motion vector predictive difference DMV.

The reference local memory 111 obtains a reference picture RfP from the external multi-frame memory 120, and outputs, as a compensation reference pixel MCp1, image data in a region of the obtained reference picture RfP indicated by a reference frame number RN and the motion vector MV, to the motion compensation unit 105. Here, the reference local memory 111 obtains, per coding processing of a current macroblock, a search region of a reference picture RfP corresponding to the current macroblock, without obtaining the entire reference picture RfP from the external multi-frame memory 120 at once. Hereinafter, the reference picture RfP indicates entire reference picture or image data of a search region of a part of that reference picture.

The motion compensation unit 105 generates a reference pixel with a sub-pixel precision from the motion compensation reference pixel MCp1 obtained from the reference local memory 111, and outputs the resultant that is a reference picture pixel MCp2.

The subtractor 103 subtracts the reference picture pixel MCp2 from the image signal Vin, and outputs a picture predictive difference DP.

The coding unit 106 performs variable-length coding on the picture predictive difference DP, the motion vector predictive difference DMV and a reference frame number RN, and outputs a coded stream Str. Furthermore, when coding the picture predictive difference DP, the coding unit 106 also decodes the coded picture predictive difference DP, and outputs the resultant that is a decoded picture predictive difference RDP.

The adder 107 adds the decoded picture predictive difference RDP to the reference picture pixel MCp2, and outputs a decoded picture RP that is the sum, to the external multi-frame memory 120.

The external multi-frame memory 120 stores the decoded picture RP from the adder 107 as a picture (a reference picture). However, for an effective use of a capacity of the external multi-frame memory 120, the image region stored in the external multi-frame memory 120 is released when the image region is unnecessary, and the decoded picture RP which does not need to be stored into the external multi-frame memory 120, in other words, the decoded picture RP which is not scheduled to be referred to, is not stored into the external multi-frame memory 120.

The capability determination unit 131 determines a data transfer capability (a total data transfer rate) of the external multi-frame memory 120, calculates a data transfer rate which is assignable to a motion estimation from among the determined data transfer capability, and notifies the reference picture setting unit 132 of the calculated data transfer rate.

The reference picture setting unit 132 selects reference pictures that are actually to be referred to for performing coding such as motion estimation on a current picture to be coded, from among the reference pictures (potential reference pictures) specified in a specification and the like, based on the data transfer amount in accordance with the data transfer rate notified from the capability determination unit 131. For example, the reference picture setting unit 132 sets plural reference pictures that are actually to be referred to, as a reference list in a list format. The reference picture setting unit 132 then notifies the set reference list to the reference memory control unit 112 and the motion estimation unit 101.

The reference memory control unit 112 controls the external multi-frame memory 120 and the reference local memory 111 so that the reference pictures set by the reference picture setting unit 132 are to be transferred from the external multi-frame memory 120 to the reference local memory 111.

In other words, the reference picture setting unit 132 according to the present embodiment restricts the data transfer amount of the reference pictures by reducing the number of the reference pictures specified in the specification and the like, so that the data transfer amount of the reference pictures to be transferred from the external multi-frame memory 120 to the reference local memory 111 becomes the data transfer rate notified from the capability determination unit 131

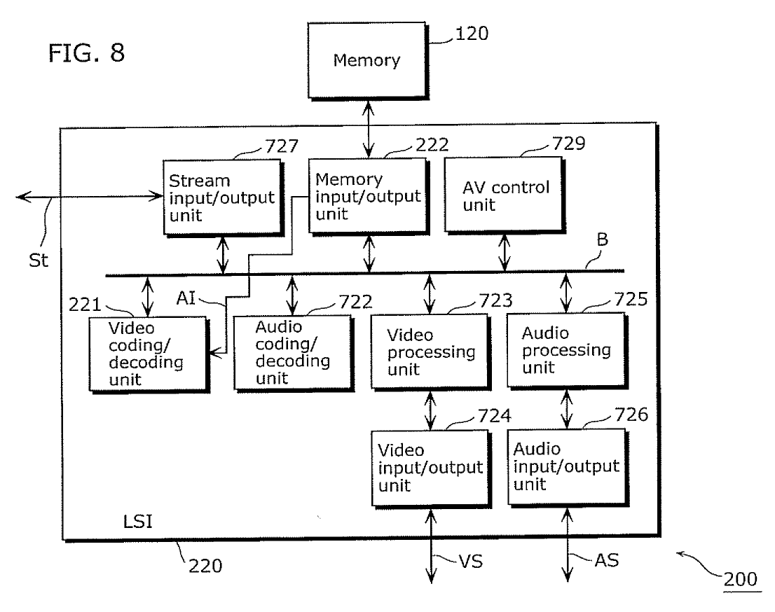

FIG. 8 is a diagram showing a structure of an AV processing apparatus having a picture coding apparatus 100 according to the present embodiment.

The AV processing apparatus 200 includes an external multi-frame memory 120 and an LSI 220.

The LSI 220 includes a bus B, a video coding/decoding unit 221, an audio coding/decoding unit 722, a video processing unit 723, a video input/output unit 724, an audio processing unit 725, an audio input/output unit 726, a stream input/output unit 727, a memory input/output unit 222, and an AV control unit 729.

In other words, the LSI 220 of the AV processing apparatus 200 according to the present embodiment includes a memory input/output unit 222 and a video coding/decoding unit 221 in place of the memory input/output unit 728 and the video coding/decoding unit 721 of the conventional AV processing apparatus 700.

The video coding/decoding unit 221 includes all constituent elements other than the external multi-frame memory 120 of the picture coding apparatus 100 and a picture decoding apparatus which decodes a coded stream Str coded by the picture coding apparatus 100.

The memory input/output unit 222 is connected to the bus B serving as an input/output interface of data to the external multi-frame memory 120, and outputs an information signal AI to the video coding/decoding unit 221. The information signal AI shows information indicating an operation frequency, a memory bas width, a memory operation protocol for determining a data transfer capability, and an access state to the external multi-frame memory 120 by each constituent element such as the audio coding/decoding unit 722 and the AV controlling unit 729.

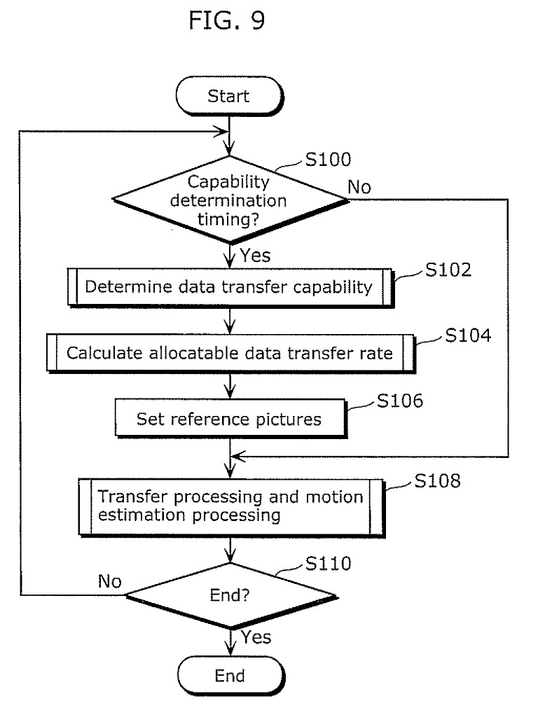

FIG. 9 is a flowchart showing an overall operation of the motion estimation apparatus 100A according to the present embodiment.

First, the capability determination unit 131 of the motion estimation apparatus 100A determines whether or not it is the timing for determining a data transfer capability (a total data transfer rate) (Step S100). For example, the capability determination unit 131 determines that a coding start timing of a sequence, a picture, or a macroblock of an image signal Vin inputted to the motion estimation unit 101, or the timing of an event occurrence is the timing of determining a data transfer capability. The event occurrence indicates, for example, a start/end of a trick-play.

Here, when determining that it is the timing for capability determination (Yes in Step S100), the capability determination unit 131 determines a data transfer capability of the external multi-frame memory 120 at the time of no operation (when the multi-frame memory 120 is not accessed to) (Step S102), and calculates a data transfer rate that can be allocated to the motion estimation processing (coding processing) (Step S104).

When the data transfer rate is calculated in Step 5104, the reference picture setting unit 132 sets, in a predetermined setting format, reference pictures which are actually to be referred to for the motion estimation processing of the current picture to be coded, in consideration with a margin and the like from the data transfer amount corresponding to the data transfer rate (Step 5106). When the reference picture is set in Step S106, the reference memory control unit 112 transfers the set reference pictures RfP to the reference local memory 111 from the external multi-frame memory 120, and the motion estimation unit 101 performs motion estimation using the reference pictures RfP transferred to the reference local memory 111 (Step S108). Accordingly, the motion estimation unit 101 determines a motion vector MV and a reference frame number RN.

The motion estimation apparatus 100A then determines whether or not to terminate the motion estimation processing in accordance with an input of an image signal Vin to the motion estimation unit 101 (Step S110), and terminates the entire motion estimation processing when determining that the termination should be performed (Yes in Step S110), and repeatedly executes the processing from Step S100 when determining that the termination should not be performed (No in Step S110).

Note that, when determining that it is not the timing for determining a data transfer capability in Step S100 (No in Step S100), the motion estimation apparatus 100A executes processing from Step S108 based on the reference pictures set by a predetermined specification and the like.

As described in the above, the motion estimation apparatus 100A according to the present embodiment determines whether or not it is the timing for determining a data transfer capability based on the information signal AI continuously during which the AV processing apparatus 200 is being activated, and dynamically restricts the number of reference pictures. Specifically, when there is a possibility that a data transfer rate that can be allocated to the motion estimation processing is changed, the motion estimation apparatus 100A calculates that data transfer rate.

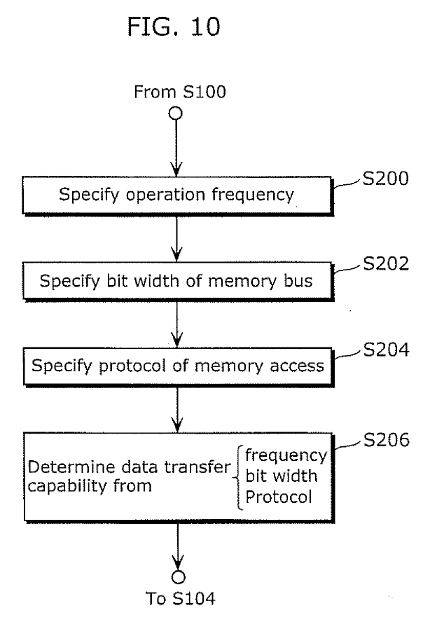

FIG. 10 is a flowchart showing a detailed determination processing of a memory transfer capability in Step S102 shown in FIG. 9.

First, the capability determination unit 131 specifies an operation frequency of the external multi-frame memory 120 based on the information signal AI transmitted from the memory input/output unit 222 (Step S200). Note that, the operation frequency of the external multi-frame memory 120 may be specified using a value obtained by timing measurement using a reference clock of the motion estimation apparatus 100A, or may be specified by calculating a point which matches an operation frequency of the external multi-frame memory 120 by changing an operation of an internal PLL. Furthermore, a user or a designer who designs the AV processing apparatus 200 may explicitly specify the operation frequency.

Next, as described in the above, the capability determination unit 131 specifies a bit width of a memory bas which connects between the external multi-frame memory 120 and the memory input/output unit 222 (a reference local memory 111), based on the information signal AI (Step S202). Note that, the bit width may be specified by examining which one of bits is effective as a result of writing and reading operations by a dummy access Furthermore, a user or a designer who designs the AV processing apparatus 200 may explicitly specify the bit width.

Furthermore, as described in the above, the capability determination unit 131 specifies a protocol of the memory access to the external multi-frame memory 120 based on the information signal AI (Step S204). Note that, a protocol may be similarly specified by a dummy access or may be specified by reading a manufacturer's code held by the external multi-frame memory 120. Furthermore, a user or a designer who designs the AV processing apparatus 200 may explicitly specify the protocol.

The capability determination unit 131 then determines a data transfer capability of the external multi-frame memory 120, that is a total data transfer rate, from the specification result in Steps S200 to S204 (Step S206).

It should be noted that the Steps S200 to S204 may be performed in any processing order. Furthermore, a user or a designer who designs the AV processing apparatus 200 may explicitly specify the data transfer capability.

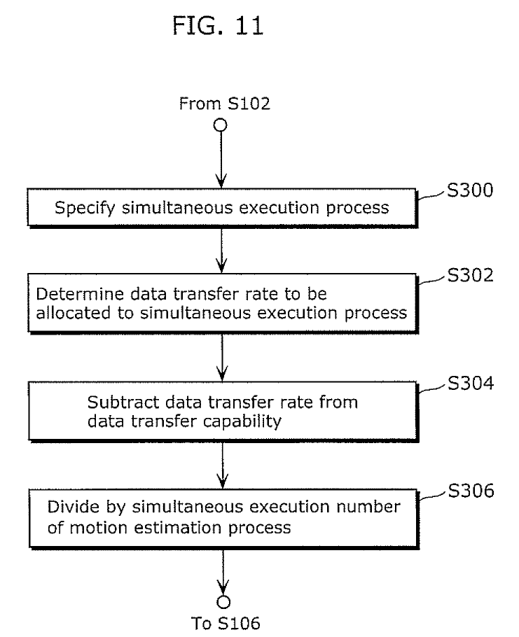

FIG. 11 is a flowchart showing a detailed process of calculating a data transfer rate in Step S104 shown in FIG. 9.

First, the capability determination unit 131 specifies a process which is simultaneously executed other than the motion estimation, based on the information signal AI transmitted from the memory input/output unit 222 (Step S300). Furthermore, a user or a designer who designs the AV processing apparatus 200 may explicitly specify the simultaneous execution process.

Next, the capability determination unit 131 determines a data transfer rate to be allocated to the simultaneous execution process (Step S302). For example, the capability determination unit 131 previously stores a unique data transfer rate for each process, and determines a data transfer rate corresponding to the simultaneous execution process specified in Step S300, from the stored data transfer rates. It should be noted that the capability determination unit 131 may estimate a data transfer rate which is actually used for the simultaneous execution process specified in Step S300.

Furthermore, the capability determination unit 131 subtracts the data transfer rate allocated to the simultaneous execution process specified in Step S302, from the data transfer capability (a total data transfer rate) determined in Step S102 shown in FIG. 9 (Step S304).

The capability determination unit 131 then divides the difference obtained in Step S304 by the number of simultaneous executions for motion estimation process (Step S306). For example, when motion estimation process (coding processing) is simultaneously performed on two image signals Vin, the capability determination unit 131 divides the difference obtained in Step S304 by 2.

Accordingly, a data transfer rate that can be allocated to one motion estimation process is calculated.

Note that, in the case where a designer who designs the AV processing apparatus 200 or a user explicitly directs the simultaneous execution process, it is realized by setting a register from the AV control unit 729 and other controllers which control a system.

Furthermore, with respect to the calculation of a data transfer rate that can be allocated to the motion estimation process, the data transfer rate may be calculated not based on the data transfer state of the external multi-frame memory 120 but based on, for example, a stream conversion from MPEG-2 to H.264 specification. Specifically, the allocatable data transfer rate is calculated so as to be a smaller value for a low electricity or high-speed data transfer. When a maximum compression rate is wished to be increased, the allocatable data transfer rate is calculated so as to be a greater value.

Here, the transfer process and motion estimation process in Step S108 shown in FIG. 9 are described in detail.

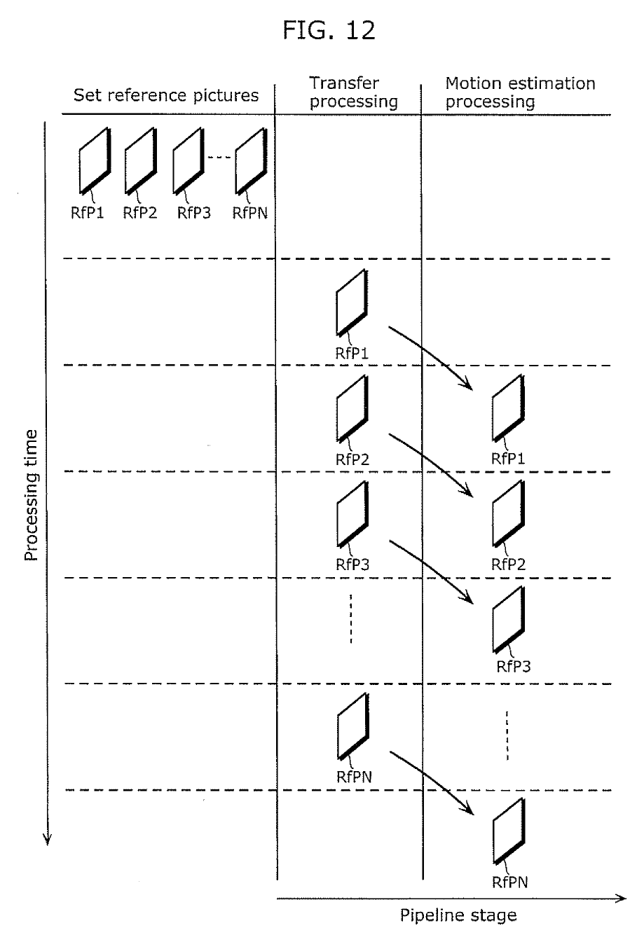

FIG. 12 is a diagram for explaining an outline of the transfer process and motion estimation process. Note that, in FIG. 12, a vertical line indicates a processing time and a horizontal line indicates a pipeline stage.

In the case where the reference picture setting unit 132 sets reference pictures RfP1 to RfPN, the reference memory control unit 112 firstly transfers the reference picture RfP1 from the external multi-frame memory 120 to the reference local memory 111.

The motion estimation unit 101 performs motion estimation processing with reference to the reference picture RfP1 transferred to the reference local memory 111. Furthermore, herein, the reference memory control unit 112 transfers a subsequent reference picture RfP2 from the external multi-frame memory 120 to the reference local memory 111.

The motion estimation unit 101 performs estimation processing with reference to the reference picture RfP2 transferred to the reference local memory 111, and the reference memory control unit 112 further transfers the subsequent transfer picture RfP3 from the external multi-frame memory 120 to the reference local memory 111.

The reference memory control unit 112 and the motion estimation unit 101 thus respectively execute transfer processing and motion estimation processing by pipeline processing.

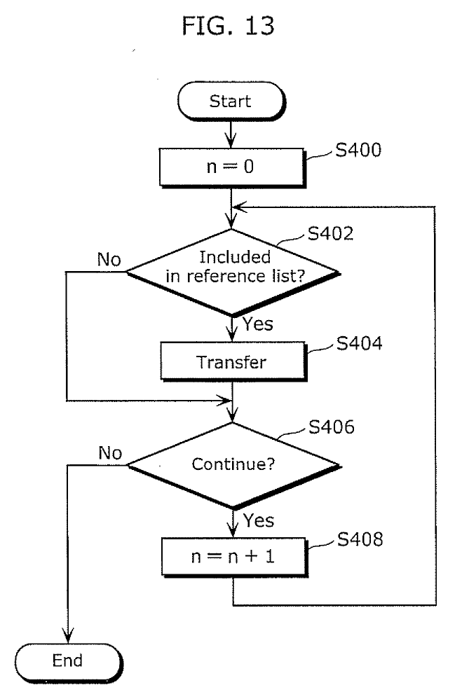

FIG. 13 is a flowchart showing the transfer processing performed by the reference memory control unit 112.

First, the reference memory control unit 112 initializes the value n of the processing loop relating to the reference picture RfP to 0 (Step S400). Next, the reference memory control unit 112 determines whether or not an n-th reference picture RfP is included in the reference list set by the reference picture setting unit 132 (Step S402). When determining that the n-th reference picture RfP is included in the reference list (Yes in Step S402), the reference memory control unit 112 transfers the n-th reference picture RfP from the external multi-frame memory 120 to the reference local memory 111 (Step S404). The reference memory control unit 112 determines whether or not, for a current picture to be coded, all reference pictures specified in a specification or an algorithm are processed in the process of Step S402, in other words, whether or not the transfer processing should be continued (Step S406).

On the other hand, when determining that the n-th reference picture RfP is not included in the reference list in Step S402 (No in Step S402), the reference memory control unit 112 executes the process of Step S406 without transferring the n-th reference picture RfP.

When determining that the transfer processing should be continued in Step S406 (Yes in Step S406), the reference memory control unit 112 increments the n-th reference picture (Step S408), and repeats the processes from Step S402. Furthermore, when determining that the transfer processing should not be continued (No in Step S406), the reference memory control unit 112 terminates entire transfer processing.

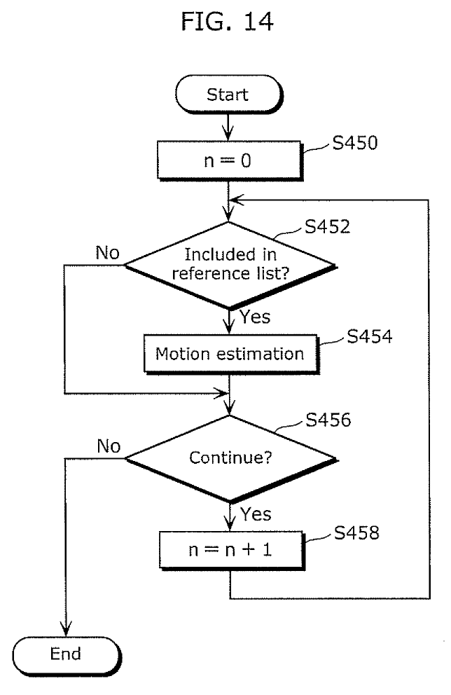

FIG. 14 is a flowchart showing motion estimation processing performed by the motion estimation unit 101.

First, the motion estimation unit 101 initializes the value of the processing loop relating to a reference picture RfP to 0 (Step S450). Next, the motion estimation unit 101 determines whether or not the n-th reference picture RfP is included in the reference list set by the reference picture setting unit 132 (Step S452). When determining that the n-th reference picture is included in the reference list (Yes in Step S452), the motion estimation unit 101 performs motion estimation processing on the n-th reference picture RfP (Step S454). The motion estimation unit 101 then determines whether or not, for a current picture to be coded, all reference pictures identified by a specification or an algorithm are processed by the process of Step S452, in other words, whether or not the motion estimation processing should be continued (Step S456).

On the other hand, when determining that the n-th reference picture RfP is not included in the reference list in Step S452 (No in Step S452), the motion estimation unit 101 executes process of Step S456 without transferring the n-th reference picture RfP.

When determining that the transfer processing should be continued in Step S456 (Yes in Step S456), the motion estimation unit 101 increments the n-th reference picture (Step S458), and repeats the processes from Step S452. Furthermore, when determining that the transfer processing should not be continued (No in Step S456), the motion estimation unit 101 terminates entire transfer processing.

Such motion estimation processing according to the present embodiment shall be described in comparison with conventional motion estimation processing.

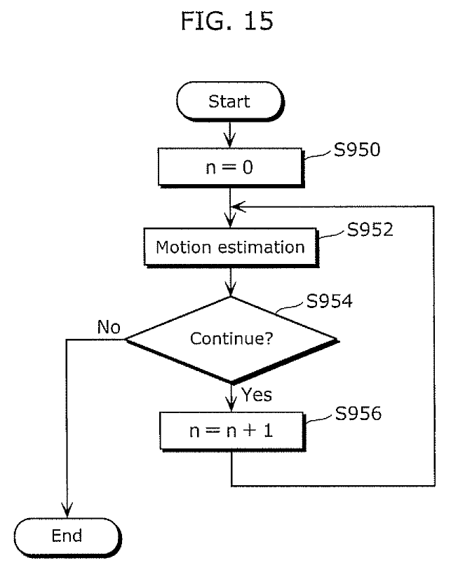

FIG. 15 is a flowchart showing the conventional motion estimation processing.

A conventional motion estimation unit initializes an n (Step S950), and performs motion estimation processing on an n-th reference picture RfP (Step S952). The motion estimation unit then determines whether or not, for a current picture to be coded, all reference pictures specified in a specification or an algorithm are processed by the process in Step S952, in other words, whether or not the motion estimation processing should be continued (Step S954). When determining that the motion estimation processing should be continued (Yes in Step S954), the motion estimation unit increments the n-th reference picture (Step S956), and repeats the processes from Step S952.

Compared with such conventional motion estimation processing, the motion estimation processing of the present embodiment does not have a big difference in processing details. However, it only differs to include the process of Step S452 shown in FIG. 14. Accordingly, the motion estimation processing of the present embodiment can be easily realized from the conventional basic motion estimation processing.

Thus, in the present embodiment, when the data transfer capability of the external multi-frame memory 120 is high, in other words, when there is a sufficient data transfer rate that can be allocated to the motion estimation processing, the number of reference pictures is not restricted so that a current picture to be coded can be motion-estimation processed with reference to all pictures scheduled to be referred to in the external multi-frame memory 120 as reference pictures, and when the current picture coded by the motion estimation is decoded, the degradation in quality of the current picture can be prevented. Furthermore, when the data transfer capability of the external multi-frame memory 120 is low, in other words, when there is not a sufficient data transfer rate that can be allocated to the motion estimation processing, the number of reference pictures is restricted so that, for example, only one potential reference picture from among plural potential reference pictures stored in the external memory is transferred to an internal memory as a reference picture. Therefore, a breakdown of an entire system which shares the external multi-frame memory 120 with other processes can be prevented. Consequently, the system breakdown can be prevented without evenly decreasing the quality of a picture to be decoded. Furthermore, a designer of a system can design the system without too much worrying about an access state of the external memory.

In other words, in the present embodiment, the data transfer capability accessible to the external multi-frame memory 120 can be made for its maximum use and the number of pictures to be referred to for the motion estimation can be increased when there is an allowance in the data transfer rate. Therefore, in an AV recorder using the motion estimation apparatus 100A and the like, the quality of coded picture can be increased to the maximum as long as the system operations are not broken down. Furthermore, in the method described in the present embodiment, the number of pictures can be optimized without changing a structure of a Group Of Picture (GOP).

As described in the above, in a state where the motion estimation apparatus 100A and the external multi-frame memory 120 are connected to each other, a system configuration with the maximum use of the data transfer capability can be realized, and a best coded picture quality can be obtained in a manner that the system designer of an AV recorder using the motion estimation apparatus 100A and the like does not need to worry too much about the transfer capability of the external multi-frame memory 120 to be connected to.

(First Variation)

Here, a first variation of the aforementioned embodiment shall be described.

The reference picture setting unit 132 according to the aforementioned embodiment sets, as a reference list, plural reference pictures to be referred to by a picture to be coded. A reference picture setting unit according to the present variation sets the maximum number (setting number) of reference pictures that are actually to be referred to. The reference picture setting unit then stops transferring the reference pictures to the reference memory control unit 112 when the number of reference pictures transferred from the external multi-frame memory 120 to the reference local memory 111 reaches the setting number.

In this case, a motion estimation unit according to the present variation performs motion estimation processing based on the number of reference pictures set by the reference picture setting unit.

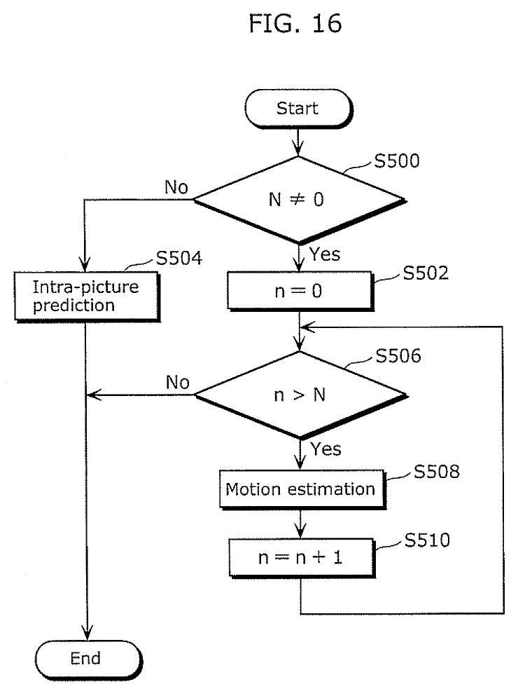

FIG. 16 is a flowchart showing the motion estimation processing performed by the motion estimation unit according to the present variation.

First, the motion estimation unit determines whether or not the setting number N set by the reference picture setting unit is 0 (Step S500). When determining that the setting number N is not 0 (Yes in Step S500), the motion estimation unit initializes the value n of the processing loop relating to the reference picture RfP to 0 (Step S502). On the other hand, when determining that the setting number N is 0 (No in Step S500), the motion estimation unit executes intra-picture prediction processing on a current picture to be coded (Step S504).

When the value n is initialized in Step S502, the motion estimation unit determines whether or not the value n is smaller than N (Step S506). When determining that n is smaller than N (Yes in Step S506), the motion estimation unit performs motion estimation on an n-th reference picture RfP (Step S508), increments the n (Step S510), and repeats the processes from Step S506. On the other hand, when determining that n is equal to N or larger (No in Step S506), the motion estimation unit terminates the motion estimation processing without performing motion estimation on the n-th reference picture RfP.

Accordingly, in the present variation, a similar effect as obtained in the aforementioned embodiment can be obtained by setting the maximum number of reference pictures.

(Second Variation)

Here, a second variation of the aforementioned embodiment shall be described.

In the present embodiment, the motion estimation apparatus 100A occasionally determines whether or not it is the timing of determining a data transfer capability, while the AV processing apparatus 200 is being activated, determines the data transfer capability when it is such timing, and calculates a data transfer rate that can be allocated to the motion estimation processing. In other words, the motion estimation apparatus 100A of the aforementioned embodiment dynamically changes the data transfer rate that can be allocated to the motion estimation processing while the AV processing apparatus 200 is being activated.

A motion estimation apparatus according to the present variation performs determination of the data transfer capability and the like when the AV processing apparatus is activated, in other words, only when the motion estimation apparatus is initialized. Specifically, the motion estimation apparatus according to the present variation fixes the data transfer rate assignable to the motion estimation processing instead of changing it, while the AV processing apparatus is being activated.

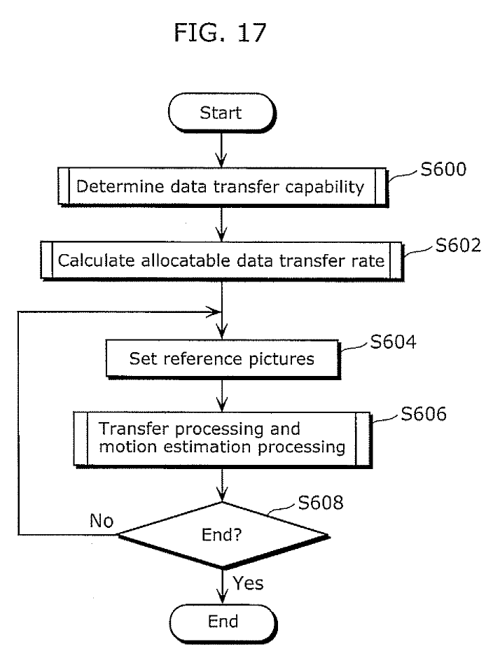

FIG. 17 is a flowchart showing an overall operation of the motion estimation apparatus according to the present variation.

A capability determination unit of the motion estimation apparatus according to the present variation determines a data transfer capability of the external multi-frame memory 120 at the time of which the external multi-frame memory 120 is not operated (is not accessed to), based on an information signal AI when the AV processing apparatus is activated (Step S600), and calculates a data transfer rate that can be allocated to the motion estimation processing (coding processing) (Step S602).

When the data transfer rate is calculated in Step S602, the reference picture setting unit of the motion estimation apparatus sets reference pictures that are actually referred to for the motion estimation processing to be performed on a current picture to be coded, in consideration of a margin and the like from the data transfer amount according to the calculated data transfer rate (Step S604). After setting the reference pictures in Step S604, the motion estimation apparatus transfers the set reference pictures RfP from the external multi-frame memory 120 to the reference local memory 111, and performs motion estimation on the current picture using the reference pictures RfP transferred to the reference local memory 111 (Step S606).

The motion estimation apparatus then determines whether or not to terminate its motion estimation processing in accordance with an input of an image signal Vin (Step S608). It terminates entire motion estimation processing when determining to terminate the motion estimation processing (Yes in Step S608), and it repeats the processes from Step S604 when determining not to terminate the motion estimation processing (No in Step S608).

The motion estimation apparatus according to the present variation calculates a data transfer rate that can be allocated to the motion estimation processing when the AV processing apparatus is activated, and sets reference pictures in accordance with the data transfer rate calculated while the AV processing apparatus is being activated. Specifically, the motion estimation apparatus sets reference pictures in accordance with the data transfer rate calculated at the time when the AV processing apparatus is activated, without newly calculating a data transfer rate even when an event occurs in the AV processing apparatus while the AV processing apparatus is being activated. Furthermore, the processes from Steps S604 to S608 according to the present variation are same as the processes from Steps S106 to S110 shown in FIG. 9 of the aforementioned embodiment.

Note that, in the present variation, the data transfer rate is calculated when the AV processing apparatus is activated, it is also possible that a fixed data transfer rate that can be allocate to the motion estimation processing in accordance with the external multi-frame memory 120 may be determined when a system designer designs the AV processing apparatus.

(Third Variation)

Here, a third variation of the aforementioned embodiment shall be described.

In the aforementioned embodiment, the reference picture setting unit selects and sets reference pictures that are actually referred to from among the reference pictures specified in a specification and the like. In the first variation, the reference picture setting unit sets the maximum number of reference pictures that are actually referred to.

A reference picture setting unit according to the present variation changes a GOP structure of a coded stream Str in accordance with a data transfer rate that can be allocated to the motion estimation processing. For example, the reference picture setting unit changes the GOP structure from the field structure to the frame structure.

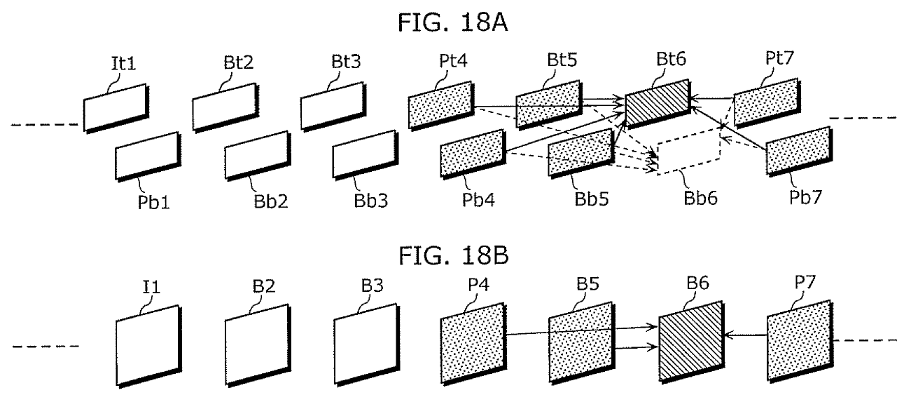

FIG. 18 is a schematic diagram for explaining that the GOP structure is changed.

For example, the coded stream Str to be generated in compliance with a specification and the like has a field structure as shown in FIG. 18A. In such coded stream Str, a pair of fields It1 and Pb1 forms an I picture; a pair of fields Bt2 and Bb2, a pair of fields Bt3 and Bb3, a pair of fields Bt5 and Bb5, and a pair of fields Bt6 and Bb6 respectively form an B picture; and a pair of fields Pt4 and Pb4 and a pair of fields Pt7 and Pb7 respectively form a P picture. Furthermore, each field is coded in order of fields It1, Pb1, Pt4, Pb4, Bt2, Bb2, Bt3, Bb3, Pt7, Pb7, Bt5, Bb5, Bt6, and Bb6, and each field is displayed in the order shown in FIG. 18A. Also, the fields It1, Pb1, Bt2, Bb2, Bt3, and Bb3 are coded fields, but they are the fields which are no longer used as references. The fields Pt4, Pb4, Bt5, Bb5, Pt7 and Pb7 are fields used as references for coding, and the field Bt6 is a current field to be coded. Further, the field Bb6 is a field which has not been coded.

Specifically, when the field Bt6 of the B picture is coded, six fields of fields Pt4 and Pb4 of a P picture, fields Pt7 and Pb7 of a P picture and fields Bt5 and Bb5 of a B picture are referred to as reference pictures. Furthermore, even in the case where the field Bb6 of the B picture is coded, six fields of fields Pt4 and Pb4 of a P picture, fields Pt7 and Pb7 of a P picture, and fields Bt5 and Bb5 of a B picture are referred to as reference pictures. Accordingly, in the field structure, it is necessary to transfer image data for six pictures in order to perform coding (motion estimation) on a B picture.

A reference picture setting unit changes the coded stream Str having such field structure to a frame structure shown in FIG. 18B. In such coded stream Str, each picture is coded in order of an I picture I1, a P picture P4, a B picture B2, a B picture B3, a P picture P7, a B picture B5, and a B picture B6, and each picture is displayed in order shown in FIG. 18B. Furthermore, the pictures I1, B2 and B3 are coded pictures but they are no longer used as reference pictures. The pictures P4, B5 and P7 are pictures used as reference pictures for coding, and a picture B6 is a current picture to be coded.

Specifically, when the B picture B6 is coded, three pictures of the P picture P4, P picture P7 and B picture B5 are referred to as reference pictures. Accordingly, in a frame structure, it is necessary to transfer image data for three pictures in order to perform coding (motion estimation) of a B picture.

Therefore, in the present variation, in the case where a sufficient data transfer rate of reference pictures cannot be secured in the AV processing apparatus, the system breakdown can be prevented by having a GOP structure as shown in FIG. 18B, in other words, by changing the reference relationship. Note that, in the present variation, it is assumed a GOP structure which does not allow a reference over an I picture and a P picture.

(Fourth Variation)

Here, a fourth variation of the aforementioned embodiment shall be described.

The reference picture setting unit 132 according to the aforementioned embodiment sets, as a reference list, reference pictures that are actually referred to by the current picture to be coded. The reference picture setting unit of the first variation sets the maximum number of reference pictures that are actually referred to. Specifically, in the aforementioned embodiment and the first variation, the data transfer rate of the reference pictures is restricted to the data transfer rate that can be allocated to the motion estimation processing of the external multi-frame memory 120, by restricting the number of reference pictures.

The reference picture setting unit of the present variation narrows down a range of a reference picture in which motion estimation is performed (searching range), instead of restricting the number of reference pictures. The data transfer amount of reference pictures are thus reduced by narrowing down the searching range. As a result, the data transfer rate of the reference picture can be set within the data transfer rate that can be allocated to the motion estimation processing of the external multi-frame memory 120.

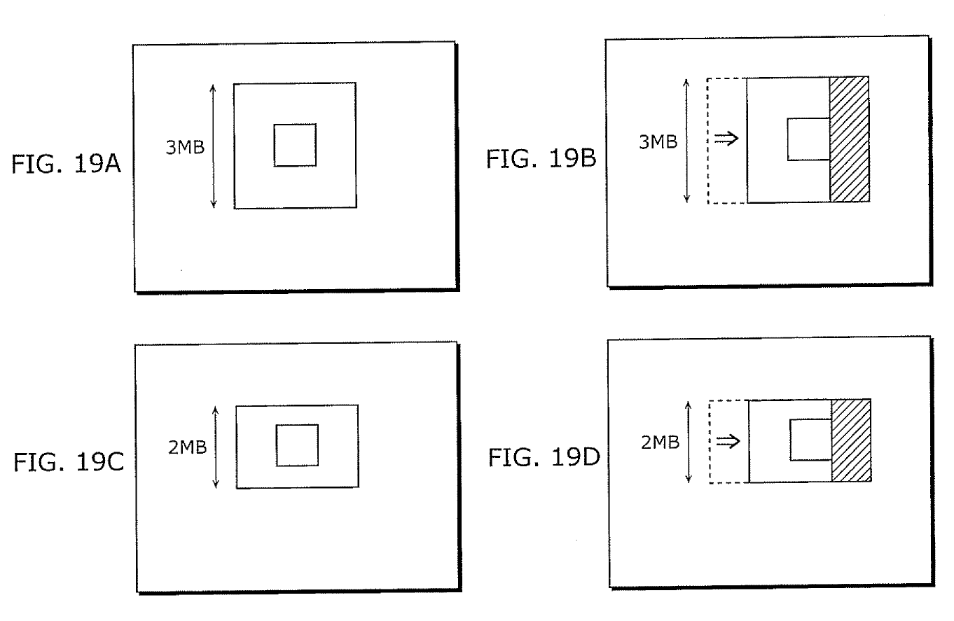

FIG. 19 is a diagram for explaining to narrow down the searching range.

The motion estimation processing of a current picture to be coded is performed, for example, on a macroblock basis. As shown in FIG. 19A, the searching range of a reference picture is 3×3 macroblocks having, in a center, a macroblock positioned corresponding to a macroblock to be estimated.

The reference memory control unit 112 transfers the image data in the searching range of the reference picture from the external multi-frame memory 120 to the reference local memory 111, and stores the transferred image data into the reference local is memory 111. The motion estimation unit 101 estimates, from the searching range, a region having an image which is most approximate to an image of a current macroblock to be estimated, using the image data in the searching range stored in the reference local memory 111.

Here, when a current macroblock of a picture to be coded is moved to a macroblock adjacent to the right of the current macroblock, as shown in FIG. 19B, the searching range in the reference picture is also moved for one macroblock to the right.

Specifically, the reference memory control unit 112 transfers image data in a region newly included in the moved searching range (a shaded region in FIG. 19B) from the external multi-frame memory 120 to the reference local memory 111, and stores the transferred image data into the reference local memory 111. Furthermore, the reference memory control unit 112 deletes, from the reference local memory 111, the image data in a region which is not included in the searching range which has been already stored in the reference local memory 111.

The reference memory control unit 112 thus transfers image data in a region which is newly included in a searching range from the external multi-frame memory 120 to the reference local memory 111, every time when a current macroblock to be estimated is changed. The image data in a region which is newly included is data for three macroblocks. Accordingly, if a picture boundary portion is also transferred as in the case of the internal macroblock region in order to simplify the processing, when a reference picture is composed of 100 macroblocks, image data for 300 macroblocks are transferred per reference picture.

The reference picture setting unit according to the present variation directs the reference memory control unit 112 and the motion estimation unit 101 so that the searching range is changed from 3×3 macroblocks to 2×3 macroblocks.

As shown in FIG. 19C, the reference memory control unit 112, which received such direction, transfers image data in a searching range which is 2×3 macroblocks from the external multi-frame memory 120 to the reference local memory 111, and stores the transferred image data into the reference local memory 111. The motion estimation unit 101 similarly estimates a region having an image which is most approximate to the image in a current macroblock to be estimated, using the image data in a searching range stored in the reference local memory 111, from that searching range.

Here, when a current macroblock of the current picture is moved to a macroblock adjacent to the right of the current macroblock, as shown in FIG. 19D, the searching range in the reference picture is also moved for one macroblock to the right. Specifically, the reference memory control unit 112 similarly transfers the image data in a region which is newly included in a searching range (a shaded region shown in FIG. 19D), from the external multi-frame memory 120 to the reference local memory 111 every time when a current macroblock to be estimated is changed. Here, the image data which is newly included in a region is data for two macroblocks. Accordingly, if a picture boundary portion is also transferred as in the case of the internal macroblock region, when a reference picture is composed of 100 macroblocks, image data for 200 macroblocks are transferred per reference picture.

Accordingly, the data transfer amount of a reference memory can be decreased by narrowing down the searching range. As a result, the data transfer rate of that reference picture can be set within the data transfer rate that can be allocated to motion estimation processing of the external multi-frame memory 120.

Note that, each functional block in a block diagram (for example, FIG. 7 and FIG. 8) shown in the aforementioned embodiment is realized as an LSI which is typically an integrated circuit. These functional blocks may be separately integrated into one chip, or a portion or all of the functional blocks may be integrated into one chip (for example, functional blocks other than a memory may be integrated into one chip). However, since the external multi-frame memory 120 shown in FIG. 7 and the memory 120 shown in FIG. 8 need to hold large about of data, they are generally implemented as a large DRAM which is externally equipped to an LSI. However, the technical improvement may allow these memories to be integrated into one package or into one chip.

Here, while an integrated circuit is referred to as an LSI, it may be also referred to as an IC, a system LSI, a super LSI, or an ultra LSI depending on a difference in a degree of integration. Furthermore, the method of integration is not only realized by an LSI but also realized by a special circuit or a general processor. After an LSI is manufactured, a Field Programmable Gate Array (FPGA) which can perform programming, and a reconfigurable processor which can reconfigure connection and setting of circuit cells in the LSI may be used. Additionally, if a new technique of integration is introduced in place of the LSI along with development of a semiconductor technology, it is obvious that the technique may be used for integrating functional blocks. There is a possibility of applying a biotechnology and the like.

As described in the above, the motion estimation apparatus of the present invention has an operational effect that a system breakdown can be prevented without evenly decreasing the quality of a picture to be decoded.

Furthermore, the motion estimation apparatus of the present invention has an effect of preventing a system breakdown without evenly decreasing the quality of a picture to be decoded so that it can perform motion estimation with a maximum use of the transfer capability of the external multi-frame memory to be connected. For example, it is useful for realizing a DVD recorder, a hard disc recorder, a camcorder and the like which perform inter-picture prediction coding with reference to plural reference pictures using the H.264 specification.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

What is claimed is:

1. A motion estimation apparatus which estimates a motion of an image of a current picture to be coded, for the coding of the current picture, said motion estimation apparatus comprising:
a restriction unit operable to restrict a data transfer amount of image data to be transferred from an external memory, in accordance with a data transfer capability of the external memory in which the image data is stored;
an internal memory;
a transfer unit operable to transfer, to said internal memory, at least a portion of the image data stored in the external memory, the at least the portion of the image data being the data transfer amount restricted by said restriction unit; and
a motion estimation unit operable to perform motion estimation on the current picture, with reference to the at least the portion of the image data transferred to said internal memory.

2. The motion estimation apparatus according to claim 1,
wherein the external memory holds potential reference pictures which are scheduled to be referred to for motion estimation of the current picture, and
said restriction unit is operable to restrict the data transfer amount by reducing the number of the potential reference pictures.

3. The motion estimation apparatus according to claim 2,
wherein said restriction unit is operable to reduce the number of the potential reference pictures by selecting, from among the potential reference pictures stored in the external memory, one or more potential reference pictures to be transferred as reference pictures by said transfer unit.

4. The motion estimation apparatus according to claim 2,
wherein said restriction unit is operable to set a maximum number for potential reference pictures, which is smaller than the number of the potential reference pictures stored in the external memory, and to reduce the number of the potential reference pictures by stopping the transfer performed by said transfer unit when the number of the potential reference pictures transferred to as reference pictures by said transfer unit reaches the maximum number.

5. The motion estimation apparatus according to claim 4,
wherein said transfer unit is operable not to transfer any of the potential reference pictures in the case where the maximum number is set by said restriction unit at 0, and
said motion estimation unit is operable to prohibit motion estimation of the current picture, for intra-picture coding of the current picture.

6. The motion estimation apparatus according to claim 1,
wherein said restriction unit is operable to restrict the data transfer amount by changing a reference relationship between the current picture and the image data.

7. The motion estimation apparatus according to claim 1, further comprising
a calculation unit operable to calculate a data transfer rate which can be allocated to motion estimation, out of a total data transfer rate of the external memory,
wherein said restriction unit is operable to restrict the data transfer amount so that a data transfer rate of the image data to be transferred from the external memory by said transfer unit is within the data transfer rate calculated by said calculation unit.

8. The motion estimation apparatus according to claim 7,
wherein said calculation unit includes:
a transfer capability specification unit operable to specify the total data transfer rate of the external memory; and
a rate calculation unit operable to calculate the data transfer rate which can be allocated to motion estimation, out of the total data transfer rate specified by said transfer capability specification unit.

9. The motion estimation apparatus according to claim 8,
wherein said transfer capability specification unit is operable to specify the total data transfer rate using the following: a width of a bas used for data transfer performed by the external memory; an operation frequency of the external memory; and an operation protocol of the external memory.

10. The motion estimation apparatus according to claim 9,
wherein said rate calculation unit is operable to specify, for the external memory, a simultaneous execution process of accessing the external memory for a purpose other than the motion estimation simultaneously with the transfer performed by said transfer unit, and to calculate the data transfer rate which can be allocated to the motion estimation based on the specified simultaneous execution process.

11. The motion estimation apparatus according to claim 10,
wherein said rate calculation unit is operable to calculate the data transfer rate which can be allocated to the motion estimation, by subtracting the data transfer rate allocated to the simultaneous execution process from the total data transfer rate.

12. The motion estimation apparatus according to claim 11,
wherein said rate calculation unit is operable to calculate the data transfer rate which can be allocated to the motion estimation, by dividing the difference obtained from the subtraction by the number of motion estimation processes that are simultaneously executed.

13. The motion estimation apparatus according to claim 7,
wherein said calculation unit is operable to calculate the data transfer rate which can be allocated to the motion estimation when said motion estimation apparatus is initialized.

14. The motion estimation apparatus according to claim 7,
wherein said calculation unit is operable to detect a timing when there is a possibility that the data transfer rate which can be allocated to the motion estimation changes, and to calculate, at the detected timing, the data transfer rate which can be allocated to the motion estimation.

15. The motion estimation apparatus according to claim 1,
wherein said transfer unit is operable to transfer the image data stored in the external memory, for each region to be referred to by said motion estimation unit, and
said restriction unit is operable to restrict the data transfer amount by narrowing down the region.

16. A motion estimation method for estimating a motion of an image of a current picture to be coded, for the coding of the current picture, said motion estimation method comprising:
restricting a data transfer amount of image data to be transferred from an external memory, in accordance with a data transfer capability of the external memory in which the image data is stored;
transferring, to an internal memory, at least a portion of the image data stored in the external memory, the at least the portion of the image data being the data transfer amount restricted in said restricting; and
performing motion estimation on the current picture, with reference to at least the portion of the image data transferred to the internal memory.

17. An integration circuit which estimates a motion of an image of a current picture to be coded, for the coding of the current picture, said integration circuit comprising:
a restriction unit operable to restrict a data transfer amount of image data to be transferred from an external memory, in accordance with a data transfer capability of the external memory in which the image data is stored;
an internal memory;
a transfer unit operable to transfer, to said internal memory, at least a portion of the image data stored in the external memory, the at least the portion of the image data being the data transfer amount restricted by said restriction unit; and
a motion estimation unit operable to perform motion estimation on the current picture, with reference to at least the portion of the image data transferred to said internal memory.

18. A program estimating a motion of an image of a current picture to be coded, for the coding of the current picture, said program causing a computer to execute:
restricting a data transfer amount of image data to be transferred from an external memory, in accordance with a data transfer capability of the external memory in which the image data is stored;
transferring, to an internal memory, at least a portion of the image data stored in the external memory, the at least the portion of the image data being the data transfer amount restricted in said restricting; and
performing motion estimation on the current picture, with reference to the at least the portion of the image data transferred to the internal memory.
